(19) United States
(12) Patent Application Publication
(10) Pub. No.: US 2002/0005466 A1
(43) Pub. Date: Jan. 17, 2002

(54) Christmas tree stand

(76) Inventors: Martin Thurner, Strasskirchen (DE); Guenther Thurner, Strasskirchen (DE)

Correspondence Address: JORDAN AND HAMBURG LLP, 122 East 42nd Street, New York, NY, 10168, US

(21) Appl. No.: 09/879,598

(22) Filed: Jun. 12, 2001

(30) Foreign Application Priority Data
Jun. 14, 2000 (DE) 200 10 527.2

(51) Int. Cl. F16M 13/00

(52) U.S. Cl. 248/523; 248/519

(57) ABSTRACT

The invention relates to a stand for clamping rod-shaped parts, in particular Christmas trees. The stand has a tensioning device and a holding device with a number of holding elements which can be pivoted from a holding position into a release position and are prestressed in the release position by respective springs. At least one force transmission element is provided, which is guided on the holding elements and can be tensioned by means of the tensioning device. The holding elements and/or the force transmission element are/is, at least in a region in which the force transmission element is guided on the holding elements, designed in such a manner that, when relative movement takes place between the holding elements and the force transmission element, the latter slides with reduced friction on the holding elements. The springs are integrated in the respective holding elements, and the holding elements consist of a slidable plastic.

The invention relates to a stand for receiving rod-shaped parts, in particular Christmas trees.

From the prior art, a great many stands are already known, in which a Christmas tree can be clamped by means of pivotable holding elements which are actuated via a cable pull. While it is true that these stands are very simple and practical for the user to handle, that is to say they require no great expenditure of force or dexterity, they are nevertheless very expensive on account of their structural and material sophistication. To provide a stable and safe stand, materials such as metal and metal alloys are used, above all for the components to or on which force is transmitted or exerted. In particular the holding elements, by which a force transmission element in the form of a steel cable is guided, have thus also previously been made of metal. In this connection, a further problem arises as far as the safety of the Christmas tree stand is concerned. There is a risk that, after a long period of use, the steel cable will tear at the guides through the holding elements as a result of the constant friction occurring there and will consequently constitute a safety risk for the user.

It is therefore the object of the invention to produce a stand for receiving a rod-shaped part, which stand is just as practical to handle in operation as the known stands but is nevertheless more simple and less expensive to manufacture and at the same time shows as little wear as possible and is safe for the user even after a long period of use.

According to the invention, this object is achieved by a stand having the features according to claim 1. Preferred embodiments of the stand according to the invention are indicated in the dependent claims.

The stand according to the invention for clamping rod-shaped parts, in particular Christmas trees, has a tensioning device and a holding device with a number of holding elements which can be pivoted from a holding position into a release position and at least one force transmission element which is guided on the holding elements and can be tensioned by means of the tensioning device. The holding elements are prestressed in the release position by respective springs. According to the invention, the holding elements and/or the force transmission element are/is, at least in a region in which the force transmission element is guided on the holding elements, designed in such a manner that, when relative movement takes place between the holding elements and the force transmission element, the latter slides with reduced friction on the holding elements. According to the invention, the holding elements consist of a slidable plastic, and the springs for prestressing the holding elements are integrated therein. On the one hand, the arrangement or integration of the springs in the holding elements affords the advantage that the spring is protected as it is surrounded by the plastic housing of the holding element. On the other hand, this configuration also has the advantage, in addition to a space-saving effect, that risk of injury is reduced or even essentially prevented as the springs are no longer arranged separately on the holding element on the outside thereof.

The friction-reduced sliding is achieved by the use of slidable plastic for the holding elements. The force transmission element, which is guided by the holding elements and takes up great tension, can be made from steel and nevertheless guided with reduced friction in the holding elements as these are made from slidable plastic. The use of plastic material for the holding elements is first and foremost less expensive than the use of metal. Moreover, holding elements made of plastic can also be manufactured more easily; they can be, for example, injection-moulded. At the same time, this method of manufacture makes possible easier and more variable shaping. The use of materials which make possible friction-reduced sliding on account of their material properties is furthermore advantageous because the use of lubricants is thus rendered superfluous. The reduction of friction between the holding elements and the force transmission element when relative movement takes place between the holding elements and the force transmission element affords the advantage that in particular the material of the force transmission element is spared and is consequently highly durable, that is to say it will not tear even after a long period of use, which inter alia saves costs because replacing or purchasing new individual components of the stand is avoided. For the user, who could suffer serious injury from a tearing tensioned steel cable, this source of danger is advantageously eliminated. Another, not inconsiderable advantage consists in the fact that, especially when the stand is used for clamping Christmas trees, water which can be filled into the stand for watering the Christmas tree cannot damage the plastic. Holding elements made of metal will oxidize on contact with water whereas holding elements made of plastic are completely insensitive to water. The plastic used is preferably a thermoplastic, in particular polyamide, preferably with a glass fibre content of 30% by weight (PA6 GF30).

In a preferred embodiment, the respective springs guided in the holding elements are torsion springs or leg springs. Respective bolts mounted in the pivoting axis of the holding elements are guided through the springs and the holding elements.

It is especially advantageous if the bolts are likewise made of plastic and designed in an integrated manner with the holding elements. Both the holding elements and the bolts are manufactured by injection-moulding. It simplifies manufacture and the production costs if bolts and holding elements can be injection-moulded in one piece.

The holding elements preferably have openings, through which the force transmission element in each case extends and is guided. In this connection, the openings have a diameter which is slightly greater than the diameter of the force transmission element. It is especially advantageous if the openings are distinctly chamfered at their lateral edge. This reduces the tension on the force transmission element, which increases precisely at the lateral edges, and consequently once again reduces the risk of tearing it.

In another preferred embodiment, the openings are provided with bush inserts. This affords the advantage not only that the opening edges are reinforced but also that only the bush inserts themselves can be made from an especially slidable material so as to reduce friction.

The force transmission element is preferably a flexible component, in particular in the form of a steel cable, which can be subjected to tensile loading. The steel cable extends through the holding elements and, in the holding position, transmits the holding force uniformly to all the holding elements. The steel cable has a diameter which is slightly smaller than the dimensions of the openings in the holding elements.

To reduce further the friction between the holding elements and the force transmission element, it is especially advantageous if the force transmission element, that is to say the steel cable, is coated with a slidable material, Teflon being particularly suitable.

In a preferred embodiment, the holding elements are arranged about an axis of symmetry and have respective pivoting axes, about which they can be pivoted from a holding position pivoted in in the direction of the axis of symmetry, for holding the rod-shaped part, in the opposite direction into a release position, in which the rod-shaped part is released.

It is furthermore advantageous if the holding elements are designed in the form of claws which, in the holding position, press into the surface of the rod-shaped part or Christmas tree trunk without the force transmission element touching the rod-shaped part. This configuration affords even more secure retention of the rod-shaped part or of the Christmas tree in the stand.

According to a further preferred embodiment, the stand has a receiving part for receiving the rod-shaped part or the Christmas tree trunk. The holding elements are arranged uniformly on the circumference of the receiving part, that is to say at the same distance from one another and in a common plane.

In another preferred embodiment, the springs have a bend on a leg projecting into the holding elements, so that an end portion of the leg is received in a cavity formed in the holding elements. This is especially advantageous as the springs are thus fixed in the holding elements when the tensioning device in the holding elements is actuated. In this embodiment, the bolts guided through the springs are superfluous. In this connection, noses are preferably formed in an integrated manner on the holding elements, which noses provide for the mounting of the holding elements on the bearing blocks of the stand.

The invention is explained below by means of an embodiment with reference to the accompanying drawing, in which:

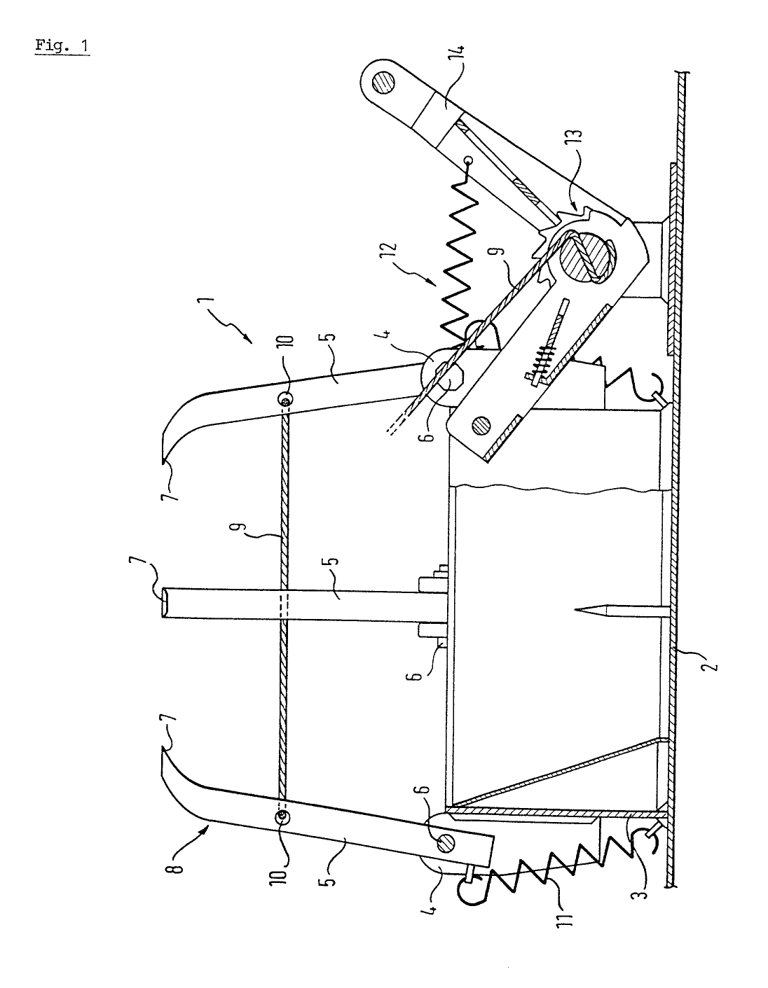

FIG. 1 shows a partly cut-away side view of a stand known from the prior art,

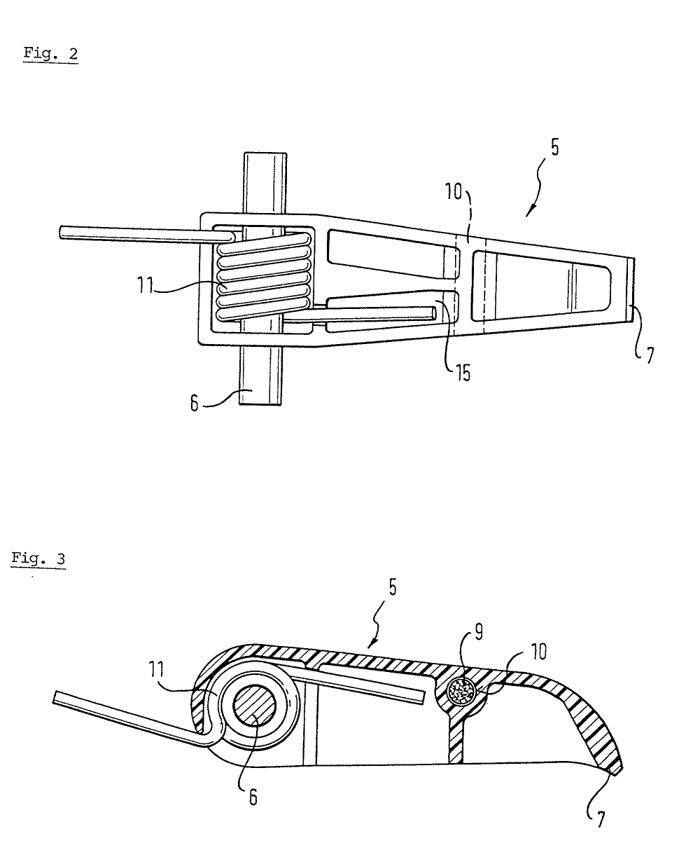

FIG. 2 shows a top view of the holding element according to the invention,

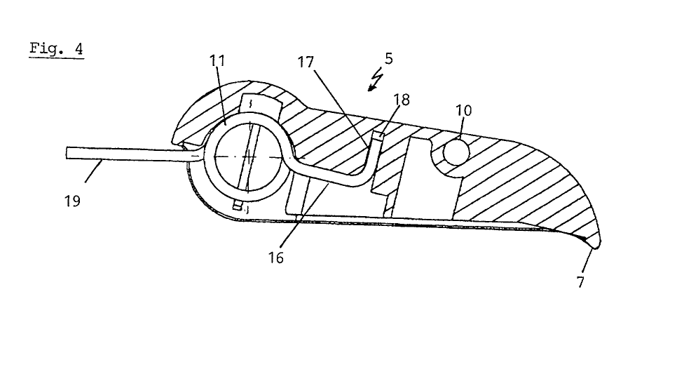

FIG. 3 shows a sectioned side view of the holding element according to the invention, and

FIG. 4 shows a sectioned side view of a further embodiment of the holding element according to the invention.

FIG. 1 illustrates a partly cut-away side view of a stand 1 known from the prior art. A cylindrical receiving part 3 serving for receiving a rod-shaped part or Christmas tree trunk (not shown here) is arranged on a baseplate 2. Holding elements 5 spaced uniformly from one another are provided above bearing blocks 4 fastened on the outer circumference of the receiving part 3, or mounted pivotably thereon via bolts 6 mounted in their respective pivoting axes. The holding elements 5, which in the holding position grip a rod-shaped part (not shown), are designed as claws 7. A force transmission element 9 in the form of a steel cable is guided through openings 10 of all the holding elements 5 to a ratchet mechanism 13 of the tensioning device 12 and can be tautened via a tensioning lever 14 in order to bring the holding elements 5 into their holding position. When the force transmission element 9 is not tensioned in the release position, the holding elements 5 are prestressed in the direction of the release position by respective restoring springs 11 which engage on the outside of the holding elements 5 and are guided from the holding elements 5 to the baseplate 2 of the stand 1. Spiral springs are used as restoring springs 11.

FIG. 2 shows a top view of the holding element 5 according to the invention, which consists entirely of plastic. The holding element has a recess 15, in which a spring 11 is received. A bolt 6, via which the holding element is connected to the bearing block 4 (not shown), is guided through the spring 11 and the holding element. The bolt 6 forms the pivoting axis, about which the holding element can be pivoted from a release position into a holding position.

FIG. 3 shows a cross section through the holding element 5 according to the invention, which is designed as a claw 7. A force transmission element 9 in the form of a steel cable is guided through an opening 10. The diameter of the steel cable is slightly smaller than that of the opening 10. The spring 11 is integrated in the holding element 5, and it can be seen that the coil and one leg protruding therefrom are received in the holding element, and a second leg of the spring 11 emerges from the holding element 5.

The sectional view shown in FIG. 4 of a further embodiment of the holding element 5 according to the invention shows that the spring 11 has one leg 19 which projects out of the holding element 5 and one leg 16 which projects into the holding element 5. The leg 16 projecting into the holding element 5 has a bend of roughly 90°, so that an end portion 17 of the leg 16 is received in a cavity 18 formed in the holding element 5 and the spring 11 is consequently fixed in the holding element 5. In contrast to the illustrative embodiment shown in FIG. 3, no bolt is used for mounting the holding element 5 or for fixing the spring 11 in the holding elements 5. For mounting the holding elements 5, noses (not shown) are instead formed on the respective side walls of the holding elements 5, which noses form the connection to the bearing blocks 4. The noses and holding elements 5 are manufactured as a single injection-moulded part.

1. Stand (1) for clamping rod-shaped parts, in particular Christmas trees, which has a tensioning device (12) and a holding device (8) with a number of holding elements (5) which can be pivoted from a holding position into a release position and are prestressed in the release position by respective springs (11), at least one force transmission element (9) being provided, which is guided on the holding elements (5) and can be tensioned by means of the tensioning device (12), and the holding elements (5) and/or the force transmission element (9) being, at least in a region in which the force transmission element (9) is guided on the holding elements (5), designed in such a manner that, when relative movement takes place between the holding elements (5) and the force transmission element (9), the latter slides with reduced friction on the holding elements, the springs (11) being integrated in the respective holding elements (5) and the holding elements (5) consisting of a slidable plastic.

2. Stand (1) according to claim 1, in which the holding elements (5) have openings (10), through which the force transmission element (9) in each case extends and is guided, the openings (10) being distinctly chamfered at their lateral edge.

3. Stand (1) according to claim 2, in which the openings (10) are provided with bush inserts.

4. Stand (1) according to claim 2 or 3, in which the force transmission element (9) is a flexible component, in particular a steel cable, which can be subjected to tensile loading, extends through the holding elements (5) and, in the holding position, transmits the holding force uniformly to all the holding elements (5), the flexible component having a diameter which is slightly smaller than the dimensions of the openings (10) in the holding elements (5).

5. Stand (1) according to one of claims 1 to 4, in which the force transmission element (9) is coated with a slidable material, in particular with Teflon.

6. Stand (1) according to one of claims 1 to 5, in which the holding elements (5) are arranged about an axis of symmetry and have respective pivoting axes (6), about which they can be pivoted from a holding position into a release position.

7. Stand (1) according to one of claims 1 to 6, in which the holding elements (5) are designed in the form of claws (7) which, in the holding position, press into the surface of the rod-shaped part without the force transmission element (9) touching the rod-shaped part.

8. Stand (1) according to one of claims 1 to 7, in which the holding elements (5) are made from a plastic, in particular a thermoplastic.

9. Stand (1) according to one of claims 1 to 8, in which the respective springs (11) integrated in the holding elements (5) are torsion springs, respective bolts (6) mounted in the pivoting axis of the holding elements (5) being guided through the springs and the holding elements (5).

10. Stand (1) according to one of claims 1 to 9, in which the bolts (6) are made of plastic, and the holding elements (5) and the respective bolts (6) are designed in an integrated manner.

11. Stand (1) according to one of claims 1 to 8, in which the springs (11) have a bend on a leg (16) projecting into the holding elements (5), so that an end portion (17) of the leg (16) is received in a cavity (18) formed in the holding elements (5).

12. Stand (1) according to one of claims 1 to 8, in which noses are formed on the holding elements (5) for their mounting on the stand (1).
